(19) United States
(12) Patent Application Publication
(10) Pub. No.: US 2009/0182776 A1
(43) Pub. Date: Jul. 16, 2009

(54) Imaging apparatus, image management method, and program

(75) Inventor: Takashi Nunomaki, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/319,925

(22) Filed: Jan. 14, 2009

(30) Foreign Application Priority Data
Jan. 15, 2008 (JP) P2008-005671

(51) Int. Cl. G06F 17/30

(52) U.S. Cl. 707/104.1; 707/E17.019

(57) ABSTRACT

Disclosed herein is an imaging apparatus including: removable recording section configured to store a database in which pieces of registered information are stored, and image files; and control section configured to determine at a predetermined timing whether there is an incompatibility between the pieces of registered information and the image files stored in the recording section, and, if there is an incompatibility between the pieces of registered information and the image files, cause the pieces of registered information and the image files to be compatible with each other.

### CROSS REFERENCES TO RELATED APPLICATIONS

The present invention contains subject matter related to Japanese Patent Application JP 2008-005671 filed in the Japan Patent Office on Jan. 15, 2008, the entire contents of which being incorporated herein by reference.

### BACKGROUND OF THE INVENTION

1. Field of the Invention

The present invention relates to an imaging apparatus, such as a digital camera, that is capable of recording image data on a removable recording medium, an image management method, and a program.

2. Description of the Related Art

Known imaging apparatuses, such as digital cameras, allow recording image data on recording media, such as Memory Sticks (R), that can be removably attached to bodies of the imaging apparatuses. Users of the imaging apparatuses are able to view images based on the image data recorded on the recording media, which are displayed on a display section, such as an LCD (liquid crystal display), of the imaging apparatuses. Also, the recording media may be attached to an external device, such as a personal computer. The external device is capable of reading the image data from the recording media and storing and displaying the image data.

The storage capacity of internal memories is so great today that the internal memories are also capable of storing a large amount of image data, as are the above recording media. When there is a desire to transfer the image data stored in the internal memory to the external device in order to store the image data in the external device or view the images based on the image data with the external device, the image data stored in the internal memory is commonly copied to a storage medium.

For example, Japanese Patent Laid-open No. 2007-174556 (hereinafter referred to as Patent Document 1) discloses a digital camera. In order to determine whether image data files stored in a memory card correspond to those stored in an internal memory, this digital camera compares the image files, and if any image data file that is stored in the internal memory but not in the memory card is detected, the digital camera copies the detected image data file from the internal memory to the memory card (see paragraph [0039] of Patent Document 1).

### SUMMARY OF THE INVENTION

Patent Document 1, however, neither discloses nor suggests a technique for managing registered information using a database in the memory card.

In other words, Patent Document 1 does not disclose any solution to a problem as described below. Suppose that at least a part of the image data stored in the memory card is deleted by the personal computer or the like, and that this memory card is attached again to the digital camera. Then in a playback mode of the digital camera, even the image data that has been deleted from the memory card is also shown as image data that can be displayed, and if the user selects the deleted image data, a blue screen, instead of a corresponding image, is displayed.

As such, the present invention addresses the above-identified and other problems associated with methods and apparatuses in related art. According to an embodiment of the present invention, at times such as times of insertion of a recording medium or shifting to the playback mode, registered information as registered in a database in the recording medium is consulted to determine whether or not corresponding image data files exist, and if a certain corresponding image data file does not exist, registered information concerning this inexistent image data file is deleted from the database, so that the registered information in the database will be compatible with the image data files and that playback of no inexistent images may be suggested.

According to an embodiment of the present invention, there is provided an imaging apparatus including: a removable recording section configured to store a database in which pieces of registered information are stored, and image files; and a control section configured to determine at a predetermined timing whether there is an incompatibility between the pieces of registered information and the image files stored in the recording section, and cause the pieces of registered information and the image files to be compatible with each other if there is an incompatibility between the pieces of registered information and the image files.

Thus, the pieces of registered information and the image files are caused to be compatible with each other.

According to another embodiment of the present invention, there is provided an image management method including the steps of: determining whether there is an incompatibility between pieces of registered information stored in a database and image files, the database and the image files being stored in a removable recording section; and causing the pieces of registered information and the image files to be compatible with each other if there is an incompatibility between the pieces of registered information and the image files.

Thus, the pieces of registered information and the image files are caused to be compatible with each other.

According to yet another embodiment of the present invention, there is provided a program for causing a computer to execute steps of: determining whether there is an incompatibility between pieces of registered information stored in a database and image files, the database and the image files being stored in a removable recording section; and causing the pieces of registered information and the image files to be compatible with each other if there is an incompatibility between the pieces of registered information and the image files.

Thus, software processing based on the program causes the pieces of registered information and the image files to be compatible with each other.

For example, the present invention provides an imaging apparatus, an image management method, and a program which cause the pieces of registered information and the image files to be compatible with each other by, at times such as times of insertion of a recording medium or shifting to a playback mode, referring to the pieces of registered information in the database in the recording medium to determine whether each of the pieces of registered information has a corresponding image data file, and deleting any piece of registered information that does not have a corresponding image data file from the database, in order to prevent playback of an inexistent image from being suggested.

### BRIEF DESCRIPTION OF THE DRAWINGS

FIG. 1 is a schematic diagram illustrating the structure of an imaging apparatus according to first and second embodiments of the present invention;

FIG. 2 is a conceptual diagram illustrating a flow of a restoration process;

FIG. 3 is a flowchart illustrating a characteristic process performed by the imaging apparatus according to the first embodiment of the present invention;

FIG. 4 illustrates an exemplary screen displayed while the restoration process is being performed;

FIG. 5 is a flowchart illustrating another characteristic process performed by the imaging apparatus according to the first embodiment of the present invention;

FIG. 6 is a conceptual diagram illustrating a flow of a registration process;

FIG. 7 is a flowchart illustrating a characteristic process performed by the imaging apparatus according to the second embodiment of the present invention; and

FIG. 8 is a block diagram illustrating the structure of a digital camera according to a third embodiment of the present invention.

### DETAILED DESCRIPTION OF THE PREFERRED EMBODIMENTS

Hereinafter, preferred embodiments of the present invention will be described in detail, with reference to the accompanying drawings.

An imaging apparatus according to an embodiment of the present invention has the following functions.

(1) A restoration process performing function of, in the case where images stored in a recording medium are managed with a database, automatically deleting file information about an image that is registered in the database but does not actually exist.

(2) A restoration process performing function of, when none of files registered in the database actually exists, discarding the database as a whole and generating a new database, instead of deleting the information in the database.

(3) A registration process performing function of, in the case where the images stored in the recording medium are managed with the database, automatically registering, in the database, file information concerning any image that actually exists but is not registered in the database.

(4) A registration process performing function of, in the case where the images stored in the recording medium are managed with the database, automatically modifying the information in the database when file information registered in the database is not compatible with file information about actual images.

Of the above four functions, the first two functions concern a first embodiment of the present invention, and the last two functions concern a second embodiment of the present invention, in particular. Hereinafter, the embodiments of the present invention will be described in detail, with a focus on the above characteristic functions.

### First Embodiment

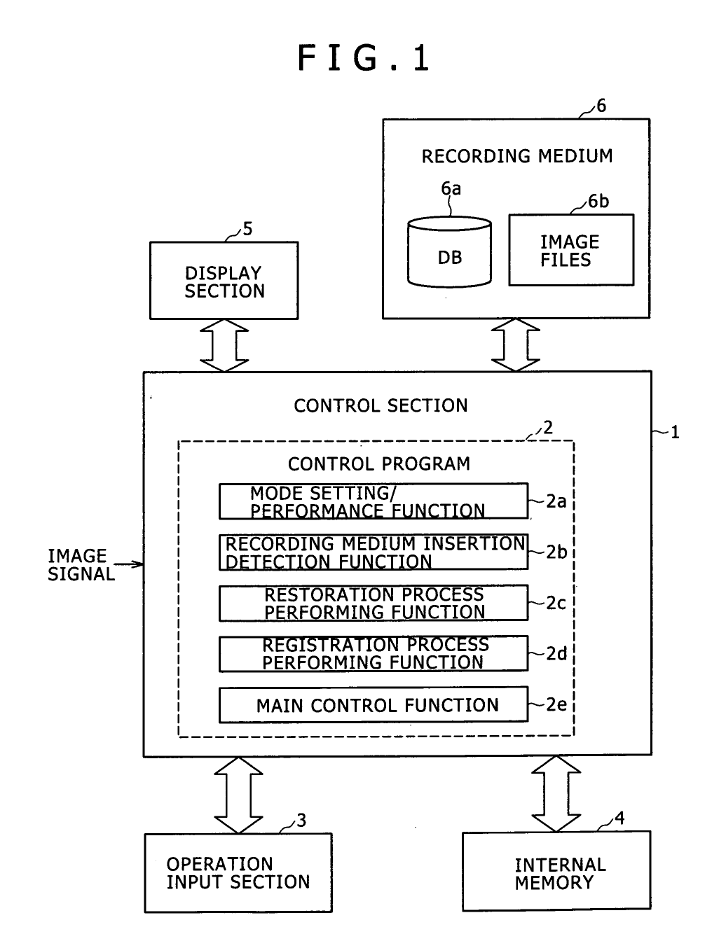

FIG. 1 is a schematic diagram illustrating the structure of an imaging apparatus according to the first embodiment of the present invention.

As shown in FIG. 1, the imaging apparatus includes a control section 1 as control means for overall control, an operation input section 3, an internal memory 4, a display section 5, and a recording medium 6.

The control section 1 reads and executes a control program 2 stored in the internal memory 4 to accomplish, at least, a mode setting/performance function 2a, a recording medium insertion detection function 2b, a restoration process performing function 2c, a registration process performing function 2d, and a main control function 2e. The recording medium 6 includes a database (hereinafter referred to as a “DB” for short) 6a for storing registered information (e.g., file path information, date/time information, etc.) and image files 6b for storing image data.

The mode setting/performance function 2a refers to a function of setting a mode based on an operation input or the like by the operation input section 3, and performing a process in the set mode. Examples of modes include a playback mode. The recording medium insertion detection function 2b refers to a function of detecting insertion of the recording medium 6 into a body of the imaging apparatus. The restoration process performing function 2c refers to a function of restoring relationships between the registered information in the DB 6a and the image files 6b when there is an incompatibility therebetween, as described later. The registration process performing function 2d refers to a function of, when a new image file 6b has been additionally stored in the recording medium 6, registering registered information concerning this new image file 6b in the DB 6a. The main control function 2e refers to a function of performing other processes.

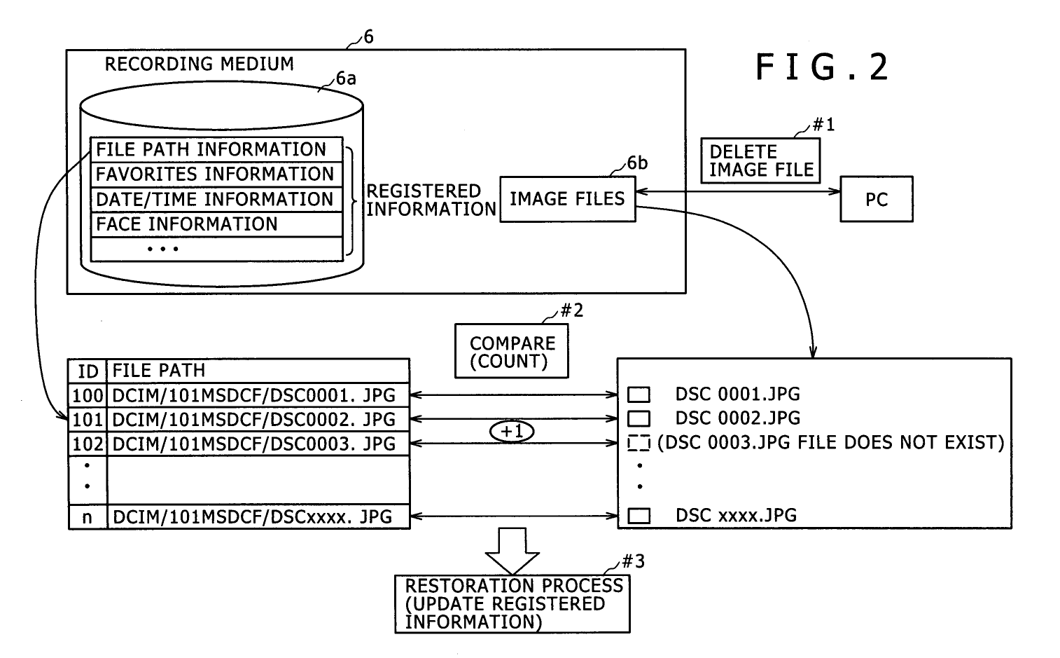

As shown in FIG. 2, the file path information, favorites information, the date/time information, face information, and so on are stored as the “registered information” in the DB 6a in the recording medium 6. The file path information, e.g., “DCIM/101MSDCF/DSC0001.JPG,” is defined such that a file name and image data are associated with each other. In addition, each piece of file path information is associated with an ID.

For example, when an image is played back in the playback mode, file path information about a corresponding file is acquired from the DB 6a in the recording medium 6, and an image file (e.g., a still image file or a thumbnail of the still image file) 6b indicated by the acquired file path information is played back.

Referring to FIG. 2, suppose here that the recording medium 6 has been removed from the body of the imaging apparatus and then attached to an external device such as a personal computer, and that some of the image files 6b in the recording medium 6 have been deleted from the recording medium 6 (#1) after being copied to the external device. In this case, the control section 1 executes the control program 2 to accomplish the restoration process performing function 2c, and performs a process as described below.

That is, the favorites information, the date/time information, the face information, and so on are stored as the registered information in the DB 6a in the recording medium 6, the file path information.

In FIG. 2, the file path information is shown as:

100/DCIM/101MSDCF/DSC0001.JPG

101/DCIM/101MSDCF/DSC0002.JPG

102/DCIM/101MSDCF/DSC0003.JPG

. . .

n/DCIM/101MSDCF/DSCxxxx.JPG

As shown above, pieces of file path information are associated with IDs 100, 101, 102, . . . , n.

With the restoration process performing function 2c, the control section 1 compares the pieces of file path information with the image files 6b, and if it is determined that one or more of the pieces of file path information does not have a corresponding image file, the control section 1 increments a counter (#2).

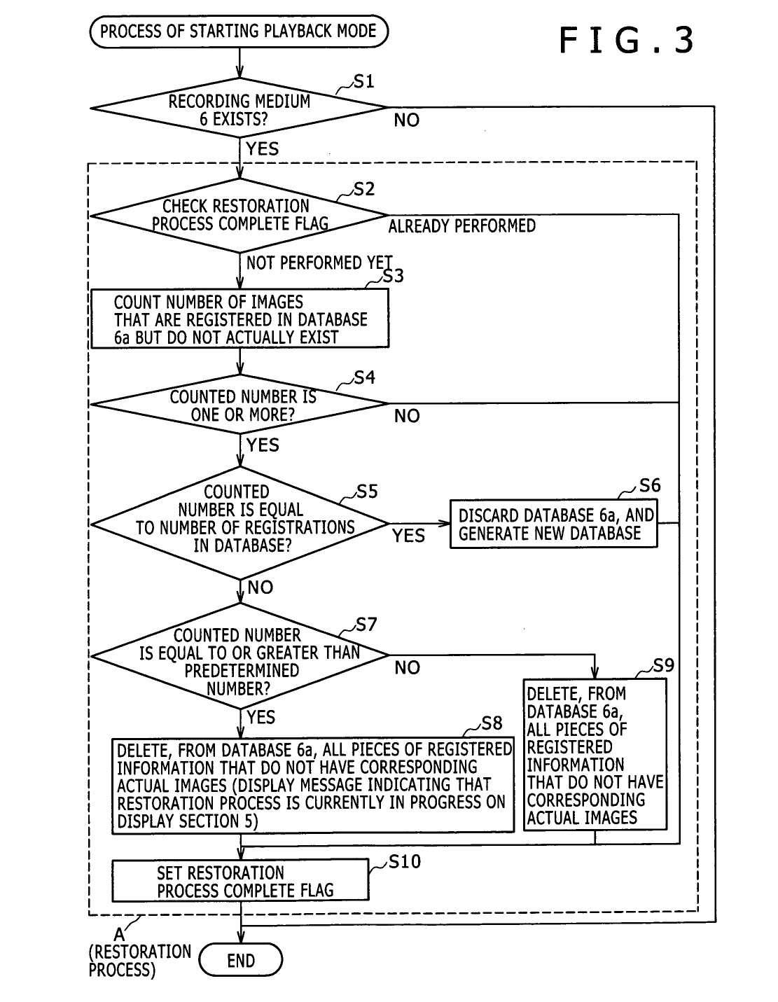

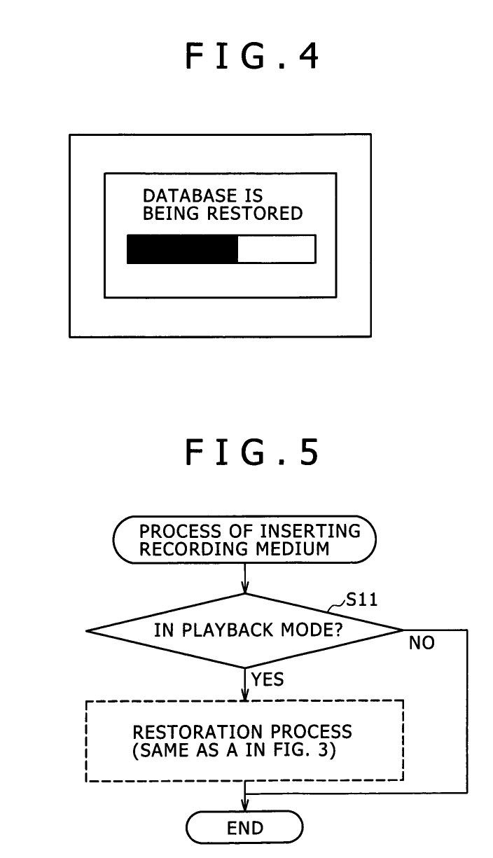

In this example, DSC003.JPEG does not exist, and the control section 1 accordingly increments the counter by one. Then, a restoration process as described below with reference to FIG. 3 is performed based on a count value of the counter (#3). In brief, if any image file whose file path information is registered is determined to be inexistent, the registered information is updated to cause the registered information to be compatible with the image files.

A characteristic process performed by the imaging apparatus according to the first embodiment of the present invention will now be described in detail below with reference to a flowchart of FIG. 3.

Based on the operation input or the like by the operation input section 3, the control section 1 uses the mode setting/performance function 2a to start the playback mode for displaying the image file on the display section 5, so that a process in this mode is started. First, the control section 1 uses the recording medium insertion detection function 2b to determine whether the recording medium 6 exists (step S1). If the recording medium 6 does not exist, this procedure is finished. Meanwhile, if the recording medium 6 exists, the control section 1 uses the restoration process performing function 2c to check a “restoration process complete flag” (step S2). The restoration process complete flag is a flag for avoiding duplication of the performance of the restoration process.

If it is determined, as a result of this check, that the restoration process has already been performed at step S2, this procedure is finished. Meanwhile, if it is determined, as a result of the check, that the restoration process has not been performed yet, the control section 1 uses the restoration process performing function 2c to count the number of images (i.e., image files 6b) that are registered in the DB 6a in the recording medium 6 but do not actually exist (step S3). Next, the control section 1 uses the restoration process performing function 2c to determine whether or not the counted number is one or more (step S4). In other words, it is determined whether or not there is one or more incompatibilities (inconsistencies) between the registered information in the DB 6a and the image files 6b.

If it is determined that the counted number is not one or more at step S4, i.e., that the counted number is zero, this procedure is finished because there is no incompatibility. Meanwhile, if it is determined that the counted number is one or more at step S4, it is determined whether or not the counted number is equal to the number of registrations in the DB 6a (step S5). If it is determined that the counted number is equal to the number of registrations in the DB 6a, that means that none of the image files 6b corresponding to the registered information in the DB 6a exists, and accordingly, the DB 6a as a whole is discarded, and the DB 6a is generated anew. Then, the procedure proceeds to step S10.

If it is determined that the counted number is not equal to the number of pieces of registered information in the DB 6a at step S5, it is then determined whether or not the counted number is equal to or greater than a predetermined number (step S7). The predetermined number is determined beforehand. The predetermined number may be defined as a number corresponding to a specific percentage of the number of IDs for the file path information in the registered information. If it is determined that the counted number is equal to or greater than the predetermined number, the control section 1 uses the restoration process performing function 2c to delete, from the DB 6a, all pieces of registered information that do not have corresponding actual images (i.e., image files 6b), and displays a message indicating that the restoration process is currently in progress on the display section 5 (step S8). This message is displayed in view of the fact that the restoration process takes a long time when the counted number is equal to or greater than the predetermined number. An example of this message is shown in FIG. 4. Note that the displaying of this message is optional.

If it is determined that the counted number is not equal to or greater than the predetermined number at step S7, that means that incompatibilities are not so large in percentage that the restoration process takes a long time, and accordingly, the control section 1 deletes, from the DB 6a, all pieces of registered information that do not have corresponding actual images (i.e., image files 6b), without displaying the above message (step S9). As a result, the performance of the restoration process is complete, and the restoration process complete flag is set in order to avoid the duplication of the performance of the restoration process (step S10). Then, this procedure is finished. Note that this restoration process complete flag is cleared when the recording medium 6 is replaced next time.

According to the above-described procedure, when the playback mode has been started as a result of an operation by the user, for example, it is determined in advance whether or not all the image files 6b that are registered in the DB 6a actually exist, and if a certain one of the image files 6b does not actually exist, the registered information concerning this file is deleted from the DB 6a, so that suggestion to the user for the playback of an inexistent image can be prevented.

Moreover, when none of the image files 6b corresponding to the registered information in the DB 6a actually exists, the DB 6a as a whole i s discarded and the DB is generated anew, instead of the file pat h information and so on being deleted from the DB 6a. This contributes to reducing a time required for the restoration process and a time for which the user has to wait.

Note that, in the procedure of FIG. 3, after the playback mode is started, it is determined whether the recording medium 6 exists, and the restoration process is performed if the recording medium 6 exists. Note that, however, as shown in FIG. 5, it may be so arranged that when the control section 1 has detected the insertion of the recording medium 6 with the recording medium insertion detection function 2b, it is determined whether the imaging apparatus is in the playback mode (step S11), and that if it is determined that the imaging apparatus is in the playback mode, the restoration process as illustrated in FIG. 3 is performed. That is, according to the procedure of FIG. 5, the above-described restoration process is performed when the recording medium 6 has been inserted into the imaging apparatus while the imaging apparatus is already in the playback mode.

### Second Embodiment

Next, the second embodiment of the present invention will be described.

An imaging apparatus according to the second embodiment of the present invention is characterized in generating a new piece of registered information and updating a content of the DB when there is any image file that actually exists in the recording medium 6 but which does not have corresponding registered information in the DB. Note that the structure of the imaging apparatus according to the second embodiment is similar to that of the imaging apparatus according to the first embodiment (see FIG. 1), and that redundant explanations are omitted here. The same reference numerals as used in FIG. 1 are used as appropriate in the following description of the second embodiment.

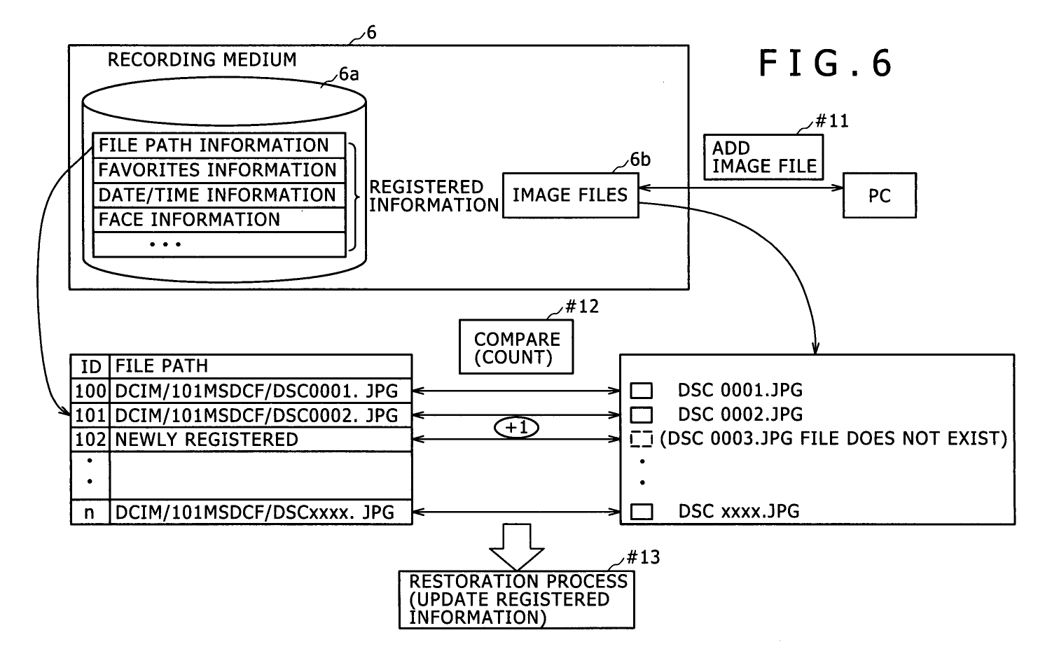

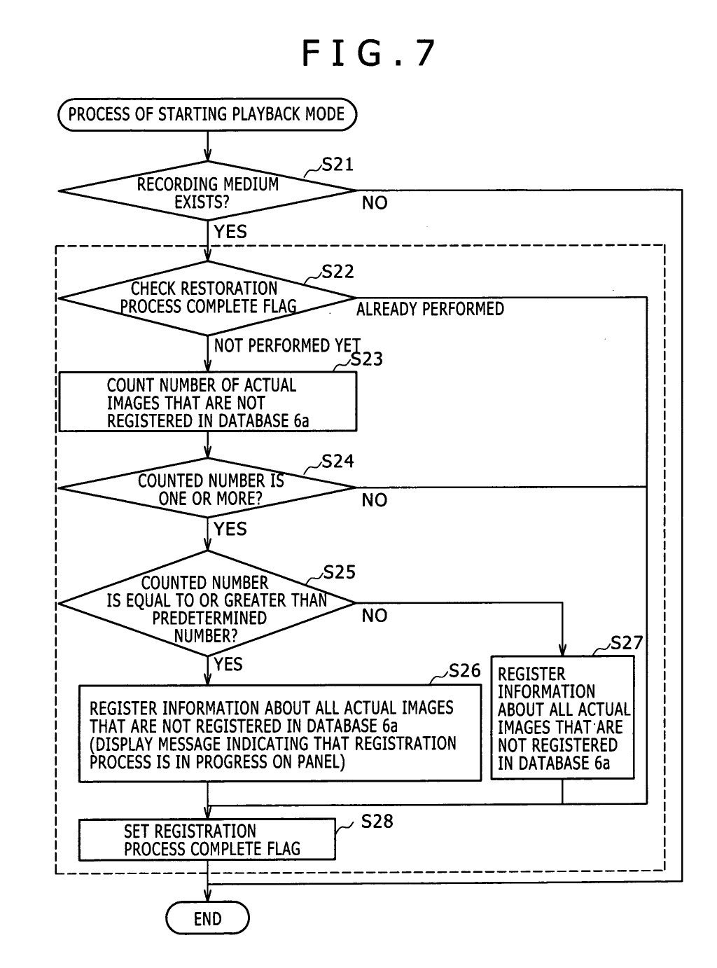

A characteristic process of this embodiment will now be described below with reference to a conceptual diagram of FIG. 6.

As in the first embodiment, in the DB 6a in the recording medium 6, the file path information, the favorites information, the date/time information, the face information, and so on are stored as the registered information. If an image file is added to the recording medium 6 by the external device, such as the personal computer (#11), the control section 1 uses the registration process performing function 2d to compare the image files 6b with the registered information in the DB 6a, and if it is determined that there is an incompatibility, i.e., that registered information concerning a certain image file 6b does not exist, the control section 1 increments the counter (#12). Then, a registration process as described below with reference to FIG. 7 is performed based on the counted number of the counter. In brief, the registered information concerning the newly added image file 6b is generated to update the registered information in the DB 6a (#13).

Next, with reference to a flowchart of FIG. 7, a characteristic process performed by the imaging apparatus according to the second embodiment of the present invention will now be described in detail below.

Based on the operation input or the like by the operation input section 3, the control section 1 uses the mode setting/performance function 2a to start the playback mode for displaying the image file on the display section 5, so that a process in this mode is started. First, the control section 1 uses the recording medium insertion detection function 2b to determine whether the recording medium 6 exists (step S21). If the recording medium 6 does not exist, this procedure is finished. Meanwhile, if the recording medium 6 exists, the control section 1 uses the registration process performing function 2d to check a “registration process complete flag” (step S22). The registration process complete flag is a flag for avoiding duplication of the performance of the registration process.

If it is determined, as a result of this check, that the registration process has already been performed at step S22, this procedure is finished. Meanwhile, if it is determined, as a result of the check, that the registration process has not been performed yet, the control section 1 uses the registration process performing function 2d to count the number of images (i.e., image files 6b) that are registered in the DB 6a in the recording medium 6 but do not actually exist (step S23). Next, the control section 1 uses the registration process performing function 2d to determine whether or not the counted number is one or more (step S24). In other words, it is determined whether or not there is one or more incompatibilities (inconsistencies) between the registered information in the DB 6a and the image files 6b.

If it is determined that the counted number is not one or more at step S24, i.e., that the counted number is zero, this procedure is finished because there is no incompatibility. Meanwhile, if it is determined that the counted number is one or more at step S24, it is determined whether or not the counted number is equal to or greater than the predetermined number (step S25). The predetermined number is determined beforehand. The predetermined number may be defined as a number corresponding to a specific percentage of the number of IDs for the file path information in the registered information. If it is determined that the counted number is equal to or greater than the predetermined number at step S25, the control section 1 uses the registration process performing function 2d to register, in the DB 6a, registered information about all actual images that do not have corresponding registered information in the DB 6a, and displays a message indicating that the registration process is currently in progress on the display section 5 (step S26). This message is displayed in view of the fact that the registration process takes a long time when the counted number is equal to or greater than the predetermined number.

Meanwhile, if it is determined that the counted number is not equal to or greater than the predetermined number at step S25, that means that incompatibilities are not so large in percentage that the registration process takes a long time, and accordingly, the control section 1 uses the registration process performing function 2d to register, in the DB 6a, the registered information about all actual images that do not have corresponding registered information in the DB 6a, without displaying the above message (step S27). As a result, the performance of the registration process is complete, and the registration process complete flag is set in order to avoid the duplication of the performance of the registration process (step S28). Then, this procedure is finished. This registration process complete flag is cleared when the recording medium 6 is replaced next time. Note that this is not essential to the present invention. The registration process complete flag may be cleared at another time.

According to the above-described procedure, when the playback mode has been started as a result of the operation by the user, for example, it is determined in advance whether or not all the image files 6b that actually exist have corresponding registered information in the DB 6a, and if there is any image file that does not have corresponding registered information in the DB 6a, the process of registering the registered information about that image file is performed. This allows all the image files 6b that actually exist to be suggested for playback.

The imaging apparatus according to the second embodiment may be modified as follows. That is, in the case where the registered information concerning the image files exists in the DB 6a, and the actual images, i.e., the image files 6b also exist but the registered information in the DB 6a is not compatible with the image files 6b for the actual images, it may be so arranged, for example, that the date/time information included in the registered information in the DB 6a is compared with date/time information in the image files 6b for the actual images, and that the registration process may be performed when they are not compatible with each other. In other words, when the imaging apparatus has entered the playback mode as a result of the operation by the user, for example, the registered information in the DB 6a may be compared with the image files 6b for the actual images, with respect to all image files 6b that actually exist and which have corresponding registered information in the DB 6a, and when there is an error in the information in the DB 6a, the erroneous registered information in the DB 6a may be modified.

### Third Embodiment

Next, a third embodiment of the present invention will be described below.

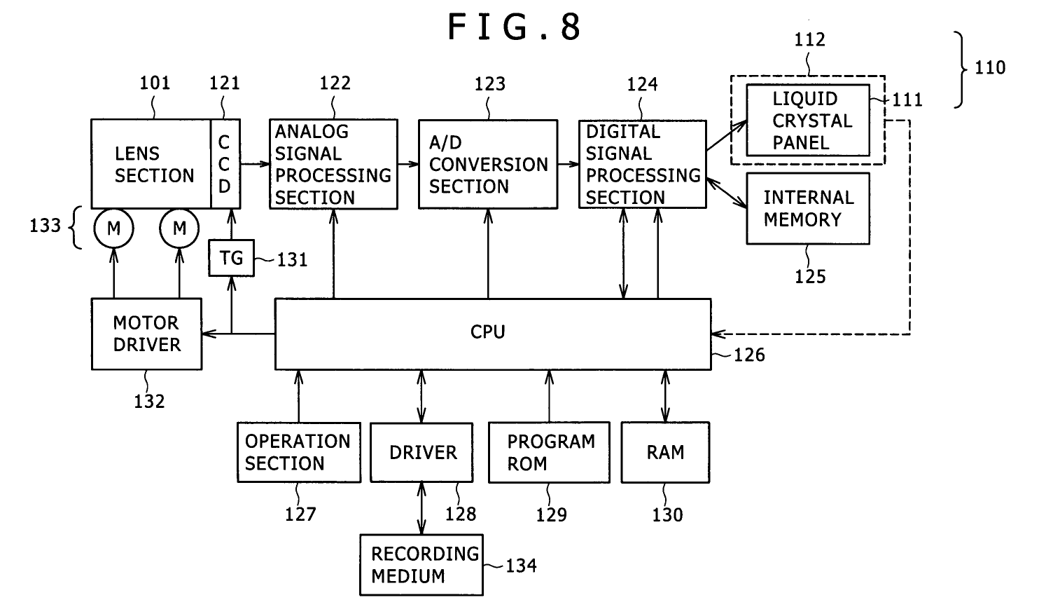

FIG. 8 illustrates the structure of a digital camera according to the third embodiment of the present invention.

The digital camera according to the third embodiment will be described more specifically than the imaging apparatuses according to the first and second embodiments.

As shown in FIG. 8, the digital camera has a lens section 101 that conceptually includes a taking lens, a diaphragm, a focus lens, and so on. An imaging element 121, such as a charge coupled device (CCD), is arranged on an optical path over which a light incident from a subject that has entered the digital camera through the lens section 101 passes. An output of the imaging element 121 is connected to an input of a digital signal processing section 124 via an analog signal processing section 122 and an analog/digital (A/D) conversion section 123. An output of the digital signal processing section 124 is electrically connected to an input of a liquid crystal panel 111. An actuator 133 is mechanically connected to the lens section 101. The actuator 133 is used to adjust the diaphragm and move the focus lens, which form part of the lens section 101. The actuator 133 is also connected to a motor driver 132, which controls driving of the actuator 133.

The digital camera further includes a central processing unit (CPU) 126, which exercises overall control over the digital camera. The CPU 126 is connected to the motor driver 132, a timing generator (TG) 131, an internal memory 125, an operation section 127, a driver 128, a program read-only memory (ROM) 129, a random access memory (RAM) 130, and a touch panel 112.

The CPU 126 reads a control program stored in the program ROM 129 and executes the read control program to function as control means, in particular, mode setting/performance means, recording medium insertion detection means, restoration process performing means, registration process performing means, main control means, and so on.

The touch panel 112 and the liquid crystal panel 111 combine to form a touch screen 110. The internal memory 125 is, for example, a high-capacity memory, such as a flash memory. The program ROM 129 stores the program executed by the CPU 126 and data that is necessary when the program is executed. The RAM 130 is used as a work area to temporarily store a program and data that are necessary when the CPU 126 performs various processes.

In the digital camera having the above structure, the CPU 126 executes the program stored in the program ROM 129 to control each part of the digital camera, and performs a predetermined process in accordance with a signal from the touch panel 112 or a signal from the operation section 127. The operation section 127 is operated by the user, and supplies a signal corresponding to a user operation to the CPU 126.

That is, if any point on the touch panel 112 is pressed, for example, by a finger of the user, i.e., if the user performs a certain operation input, the touch panel 112 detects coordinates of the pressed point, and sends a signal corresponding to these coordinates to the CPU 126, and the CPU 126 acquires predetermined information corresponding to the coordinates and performs a predetermined process based on the information.

If the light incident from the subject enters the digital camera through the lens section 101, the imaging element 121 captures the light incident from the subject, performs photoelectric conversion on the light to obtain an analog image signal, and outputs the analog image signal. At this time, under control of the CPU 126, the motor driver 132 drives the actuator 133. The driving of the actuator 133 allows the lens section 101 to be exposed from or placed within a housing of the digital camera. In addition, the actuator 133 adjusts the diaphragm, which forms a part of the lens section 101, and moves the focus lens, which forms a part of the lens section 101.

Under control of the CPU 126, the timing generator 131 supplies a timing signal to the imaging element 121. An exposure time or the like of the imaging element 121 is controlled by this timing signal. The imaging element 121 operates based on the timing signal supplied from the timing generator 131 to capture the light incident from the subject that has entered the digital camera through the lens section 101, performs the photoelectric conversion on the captured light, and supplies the resulting analog image signal, which is an electrical signal corresponding to the amounts of the light received, to the analog signal processing section 122.

Under control of the CPU 126, the analog signal processing section 122 performs analog signal processing (e.g., amplification) on the analog image signal supplied from the imaging element 121, and supplies the resulting image signal to the A/D conversion section 123.

Thereafter, under control of the CPU 126, the A/D conversion section 123 performs A/D conversion on the analog image signal supplied from the analog signal processing section 122, and supplies the resulting digital image data to the digital signal processing section 124. Under control of the CPU 126, the digital signal processing section 124 performs digital signal processing, such as noise reduction, on the digital image signal supplied from the A/D conversion section 123, and supplies the resulting signal to the liquid crystal panel 111 to display a corresponding image.

The digital signal processing section 124 compresses the digital image signal supplied from the A/D conversion section 123 in accordance with a Joint Photographic Experts Group (JPEG) system or the like, for example, and supplies the resulting compressed digital image signal to the internal memory 125, so that the compressed digital image signal is stored in the internal memory 125. Alternatively, the compressed digital image signal may be supplied to a recording medium 134, which has the DB, via the driver 128, so that the compressed digital image signal is stored in the recording medium 134.

In addition, the digital signal processing section 124 decompresses the compressed image data stored in the internal memory 125, and supplies the resulting image data to the liquid crystal panel 111 to display the corresponding image. In other words, the digital signal processing section 124 supplies the image data from the A/D conversion section 123 to the liquid crystal panel 111, so that a so-called through image is displayed on the liquid crystal panel 111.

If the user thereafter presses a shutter button, which is conceptually included in the operation section 127, the operation section 127 supplies a release signal to the CPU 126. If the release signal is supplied to the CPU 126, the CPU 126 controls the digital signal processing section 124 to compress the image data supplied from the A/D conversion section 123 to the digital signal processing section 124, and supply the compressed image data to the internal memory 125 or to the recording medium 134 via the driver 128, so that the compressed image data is stored in the internal memory 125 or the recording medium 134.

Characteristic features of this digital camera are as follows.

If the recording medium 134 is attached to the digital camera while the digital camera is in the playback mode, or if the connection of the recording medium 134 to the digital camera is detected when the playback mode has been started by the operation on the operation section 127 or the operation on the touch panel 112, the CPU 126 detects whether there is an incompatibility between the image files and the registered information in the DB in the recording medium 134, and if an incompatibility is detected therebetween, as described above with reference to the first and second embodiments, the CPU 126 performs the restoration process to delete, from the DB, any piece of registered information that does not have a corresponding image file, or performs the registration process to generate new registered information about any image file that does not have corresponding registered information, and add the generated new registered information to the DB, for example.

The first, second, and third embodiments of the present invention achieve the following effects. In the case where a certain piece of registered information in the DB 6a does not have a corresponding image file 6b, this piece of registered information is automatically deleted from the DB 6a. This eliminates the need to display a blue screen to show the user that the corresponding image does not exist. Moreover, when all the image files 6b have been deleted, the DB 6a as a whole is discarded and the DB is generated anew. This contributes to completing a maintenance process quickly.

Still further, in the case where the recording medium 6 stores any image file 6b that does not have a corresponding piece of registered information in the DB 6a, the corresponding piece of registered information is automatically registered in the DB 6a. This contributes to preventing the user from being unable to find a desired image. Still further, in the case where there is an incompatibility between the registered information in the DB 6a and the image files 6b, the registered information in the DB 6a is automatically modified to prevent an erroneous display.

The preferred embodiments of the present invention have been described above. Note, however, that the present invention is not limited to the above-described embodiments. It should be understood by those skilled in the art that various modifications, combinations, sub-combinations and alterations may occur depending on design requirements and other factors insofar as they are within the scope of the appended claims or the equivalents thereof.

For example, in the above-described embodiments, an incompatibility between the file path information and the image files is detected, and the restoration process or the registration process is performed based on the detected incompatibility. However, in the case where an instruction has been issued to play back an image file that is registered in the favorites information, the image files may be compared with only file path information associated with IDs that are managed by the favorites information to detect whether there is an incompatibility therebetween, and when there is an incompatibility therebetween, the restoration process or the registration process may be performed.

What is claimed is:

1. An imaging apparatus comprising:
removable recording means for storing a database in which pieces of registered information are stored, and image files; and
control means for determining at a predetermined timing whether there is an incompatibility between the pieces of registered information and the image files stored in said recording means, and causing the pieces of registered information and the image files to be compatible with each other if there is an incompatibility between the pieces of registered information and the image files.

2. The imaging apparatus according to claim 1,
wherein, when said control means has determined that one of the pieces of registered information in the database in said recording means does not have a corresponding image file, said control means deletes that piece of registered information which does not have a corresponding image file from the database to cause the pieces of registered information and the image files to be compatible with each other.

3. The imaging apparatus according to claim 2,
wherein the predetermined timing is a time when insertion of said recording means into the imaging apparatus has been detected after a playback operation based on any of the image files is started.

4. The imaging apparatus according to claim 2,
wherein the predetermined timing is a time when a playback operation based on any of the image files has been started after insertion of said recording means into the imaging apparatus is detected.

5. The imaging apparatus according to claim 2,
wherein, when said control means has determined that none of the pieces of registered information in the database in said recording means has a corresponding image file, said control means discards the database as a whole to cause the pieces of registered information and the image files to be compatible with each other.

6. The imaging apparatus according to claim 5,
wherein said control means generates a new database after discarding the database.

7. The imaging apparatus according to claim 1,
wherein, when said control means has determined that one of the image files does not have a corresponding piece of registered information among the pieces of registered information in the database in said recording means, said control means adds registered information corresponding to that image file to the database to cause the pieces of registered information and the image files to be compatible with each other.

8. The imaging apparatus according to claim 7,
wherein the predetermined timing is a time when insertion of said recording means into the imaging apparatus has been detected after a playback operation based on any of the image files is started.

9. The imaging apparatus according to claim 7,
wherein the predetermined timing is a time when a playback operation based on any of the image files has been started after insertion of said recording means into the imaging apparatus is detected.

10. The imaging apparatus according to claim 1,
wherein, when the pieces of registered information in the database in said recording means and the image files are not compatible with each other, said control means modifies one or more of the pieces of registered information to cause the pieces of registered information and the image files to be compatible with each other.

11. The imaging apparatus according to claim 10,
wherein the predetermined timing is a time when insertion of said recording means into the imaging apparatus has been detected after a playback operation based on any of the image files is started.

12. The imaging apparatus according to claim 10,
wherein the predetermined timing is a time when a playback operation based on any of the image files has been started after insertion of said recording means into the imaging apparatus is detected.

13. An image management method comprising the steps of:
determining whether there is an incompatibility between pieces of registered information stored in a database and image files, the database and the image files being stored in removable recording means; and
causing the pieces of registered information and the image files to be compatible with each other if there is an incompatibility between the pieces of registered information and the image files.

14. A program for causing a computer to execute steps of:
determining whether there is an incompatibility between pieces of registered information stored in a database and image files, the database and the image files being stored in removable recording means; and
causing the pieces of registered information and the image files to be compatible with each other if there is an incompatibility between the pieces of registered information and the image files.

15. An imaging apparatus comprising:
a removable recording section configured to store a database in which pieces of registered information are stored, and image files; and
a control section configured to determine at a predetermined timing whether there is an incompatibility between the pieces of registered information and the image files stored in the recording section, and cause the pieces of registered information and the image files to be compatible with each other if there is an incompatibility between the pieces of registered information and the image files.
